(19) United States
(12) Patent Application Publication
(10) Pub. No.: US 2015/0184695 A1
(43) Pub. Date: Jul. 2, 2015

(54) ROLLING BEARING ELEMENT, IN PARTICULAR ROLLING BEARING RING

(71) Applicant: Schaeffler Technologies AG & Co. KG, Herzogenaurach (DE)

(72) Inventor: Christian Schulte-Noelle, Bamberg (DE)

(73) Assignee: Schaeffler Technologies AG & Co. KG, Herzogenaurach (DE)

(21) Appl. No.: 14/414,434

(22) PCT Filed: Jun. 25, 2013
(86) PCT No.: PCT/EP2013/063186

§ 371 Date: Mar. 10, 2015

(30) Foreign Application Priority Data
Jul. 16, 2012 (DE) 10 2012 212 426.8

(51) Int. Cl. F16C 33/64; C23C 8/22; F16C 33/62; C23C 8/26

(52) U.S. Cl. CPC F16C 33/64; C23C 8/26; C23C 8/22; F16C 33/62

(57) ABSTRACT

A rolling bearing element (2), in particular a rolling bearing ring (3, 4), the rolling bearing element being made of an austenitic steel which has a composition of 16-21 mass percent chromium, 16-21 mass percent manganese, 0.5 to 2.0 mass percent molybdenum, a total of 0.8 to 1.1 mass percent carbon and nitrogen, wherein the ratio of carbon to nitrogen is 0.5 to 1.1, up to 2.5 mass percent melting-related impurities, and a remaining mass percent of iron is provided. The sum of all the components equals 100 mass percent, and the rolling bearing element has a surface layer (6) which is produced by at least one measure for diffusing carbon and/or nitrogen into regions near the surface of the rolling bearing element and which contains carbon and/or nitrogen.

The present invention relates to a rolling bearing element, in particular a rolling bearing ring, this rolling bearing element being formed from an austenitic steel.

### BACKGROUND

Rolling bearings or rolling bearing elements, such as, in particular, rolling bearing rings, rolling bodies, rolling body cages which accommodate rolling bodies, etc., are known to be used in different fields of technology. Corresponding rolling bearing elements are regularly subjected to high mechanical and/or corrosive stresses during operation.

Known rolling bearing elements are formed, for example, from non-rusting, martensitic rolling bearing steels having carbide phases intercalated therein, which do not have sufficient corrosion resistance against corrosive media, however. Rolling bearing elements made of higher-alloyed steels display an improved corrosion resistance against corrosive media; however, they generally have worse mechanical properties, in particular relating to the wear resistance, which is to be attributed to their homogeneous austenitic or, in the case of so-called duplex steels, their ferritic-austenitic microstructure.

The property profile of known rolling bearing elements is frequently not satisfactory with regard to their mechanical properties, such as, in particular, wear resistance, overrolling resistance, and also their corrosion resistance against corrosive surroundings.

### SUMMARY OF THE INVENTION

It is an object of the present invention to provide a rolling bearing element which is improved over the prior art.

The present invention provides in the case of a rolling bearing element of the type mentioned at the outset that it has a surface layer containing nitrogen (N) and/or carbon (C), which is implemented by at least one measure for diffusing carbon and/or nitrogen into near-surface areas of the rolling bearing element.

Due to the implementation of a surface layer containing nitrogen and/or carbon, the rolling bearing element according to the present invention has an outstanding property profile in regard to its mechanical properties, such as, in particular, surface hardness, wear resistance, overrolling resistance, etc., and also its corrosion resistance with respect to corrosive media, i.e., in particular in chloride-containing media, such as seawater or the like.

In particular, the rolling bearing element according to the present invention is accordingly also suitable for so-called media lubrication, in which the lubrication of the rolling bearing including the rolling bearing element according to the present invention does not take place via lubricants such as lubricating greases or lubricating oils, but rather via the particular system liquid of the usage location of the rolling bearing. Media-lubricated rolling bearings are used, for example, if seals which seal the rolling bearing are undesirable and/or common lubricants are to be omitted because of a risk of contamination. In particular media lubrication using aqueous solutions was previously problematic, as the formation of a sufficiently sustainable lubricating film between the rolling bodies and the rolling bearing bearing rings of the rolling bearing is hardly possible when using aqueous solutions, in particular also under highly dynamic conditions.

The rolling bearing element according to the present invention may thus be formed from an austenitic steel having a composition of 16-21 mass-% chromium, 16-21 mass-% manganese, 0.5 to 2.0 mass-% molybdenum, a total of 0.8 to 1.1 mass-% carbon and nitrogen, the ratio of carbon to nitrogen being 0.5 to 1.1, up to 2.5 mass-% melting-related impurities, and a remainder of mass-% of iron, the total of all components resulting in 100 mass-%.

The rolling bearing element according to the present invention is innately formed from a corrosion-resistant austenitic steel. Two possible steel variants will be described hereafter.

Two examples of concrete compositions of the above-mentioned steel result from the following table. The specifications each relate to mass-%.

| Cr | Mn | Ni | Mo | C | N |
|---|---|---|---|---|---|
| 18.80 | 18.90 | 0.40 | 0.60 | 0.49 | 0.58 |
| 18.20 | 18.90 | 0.30 | 0.70 | 0.35 | 0.61 |

Furthermore, a remainder of iron (Fe) and melting-related impurities is contained in each case, the latter having a total content of not greater than 2.5 mass-%, so that in each case a total of 100 mass-% results.

Alternatively, the rolling bearing element according to the present invention may be formed from an austenitic steel having a composition of 16-21 mass-% chromium, 16-21 mass-% manganese, either greater than 2 mass-% molybdenum or less than or equal to 2 mass-% copper, or greater than or equal to 2 mass-% molybdenum and 0.25 to 2 mass-% copper, and a total of greater than 0.5 mass-% carbon and nitrogen, the ratio of carbon to nitrogen being greater than 0.5, up to 2.5 mass-% melting-related impurities, and a remainder of mass-% of iron, the total of all components resulting in 100 mass-%.

Four examples of concrete compositions of the above-mentioned steel are provided in the following table. The specifications each relate to mass-%.

| C | N | S | Si | Cr | Mn | Mo | Cu | Ni | V | +N | C/N |
|---|---|---|---|---|---|---|---|---|---|---|---|
| 0.30 | 0.30 | <0.001 | 0.30 | 17.89 | 19.93 | 4.10 | 0.02 | 0.31 | 0.07 | 0.60 | 1.00 |
| 0.35 | 0.58 | <0.001 | 0.31 | 19.79 | 18.16 | 2.93 | 0.03 | 0.32 | 0.07 | 0.93 | 0.60 |
| 0.36 | 0.45 | <0.001 | 0.32 | 19.24 | 18.56 | 1.97 | 1.50 | 0.33 | 0.07 | 0.81 | 0.80 |
| 0.36 | 0.38 | 0.003 | 0.33 | 19.38 | 18.73 | 0.06 | 2.00 | 0.33 | 0.07 | 0.74 | 0.95 |

Furthermore, a remainder of iron (Fe) and melting-related impurities is contained in each case, the latter having a total content of up to 2.5 mass-%, so that in each case a total of 100 mass-% results.

The mentioned steels are distinguished, as mentioned, on the one hand, by an innately good corrosion resistance; however, they innately display a comparatively low wear resistance. The high solubility of the steels for foreign atoms is essential for the present invention. It is thus possible that, under suitable conditions, foreign atoms, in particular carbon and/or nitrogen, may diffuse into the microstructure of the steels. In this way, the surface layer containing carbon and/or nitrogen mentioned at the outset may be formed in the edge-proximate or near-surface areas of the rolling bearing element.

The surface layer containing carbon and/or nitrogen, which is formed by the diffusion of carbon and/or nitrogen into the microstructure, results in a type of mixed crystal hardening in the area of the surface layer, which is to be attributed in particular to an expansion of the austenitic microstructure by the introduction of carbon and/or nitrogen atoms. A high hardness of the surface layer is provided in this way.

A microstructure change of the rolling bearing element in the area of the surface layer containing carbon and/or nitrogen which is implemented as described is generally not provided, since the foreign atoms of carbon and/or nitrogen diffused into the steels are present or situated therein in particular as interstitial atoms between the actual lattice sites of the microstructure. Therefore, the austenitic microstructure of the steels is also essentially maintained in the area of the formed surface layer containing carbon and/or nitrogen.

Fundamentally, the surface layer containing carbon and/or nitrogen may thus be delimited from the remaining microstructure material of the rolling bearing element by corresponding carbon atoms and/or nitrogen atoms situated on intermediate lattice sites. The surface layer containing carbon and/or nitrogen may also be understood as the area of the rolling bearing element in which additional carbon and/or nitrogen has diffused in due to carrying out the at least one measure for diffusing carbon and/or nitrogen into near-surface areas of the rolling bearing element, the diffused carbon atoms and/or nitrogen atoms preferably being located on intermediate lattice sites.

The difference between the surface layer containing carbon and/or nitrogen and the remaining microstructure of the rolling bearing element is shown particularly clearly in the micrograph.

The surface layer containing carbon and/or nitrogen formed in this way is additionally substantially free of precipitation. The alloy elements which improve the corrosion resistance of the steels such as, in particular, chromium (Cr), molybdenum (Mo) or nitrogen (N) are not or are only slightly bound in carbide or nitride compounds by way of the additional introduction or diffusion of carbon and/or nitrogen. Accordingly, the introduction of carbon and/or nitrogen to implement the surface layer containing carbon and/or nitrogen has no substantial influence on the corrosion resistance of the steels.

In particular, an improvement of the corrosion resistance may even be possible in the area of the surface layer containing carbon and/or nitrogen, which may be explained by the introduction of additional nitrogen and/or the implementation of a stable passive layer, which ensures passivation against corrosive media, in the sense of an additional surface passivation of the rolling bearing elements. Corresponding experiments have shown, for example, that due to the implementation of a surface layer containing carbon, a noticeable improvement of the corrosion resistance against a 3.5% NaCl solution is possible. In comparison to samples without a corresponding surface layer, an increase of the pitting potential of 500 mV (against Ag/AgCl) to about 1 V was measured for samples having a surface layer containing carbon.

A rolling bearing element according to the present invention is to be understood, for example, as a rolling bearing ring, a rolling body which rolls between corresponding rolling bearing rings, or a rolling body cage for accommodating corresponding rolling bodies. In relation to the rolling bearing elements provided as rolling bearing rings, the surface layer containing carbon and/or nitrogen is therefore at least sectionally, in particular completely, implemented on the outer circumference and/or inner circumference of the rolling bearing ring and therefore in particular in the area of the rolling bearing ring which is highly stressed during operation and includes the rolling body tracks.

The surface layer containing carbon and/or nitrogen may additionally be delimited from the remaining material of the rolling bearing element in such a way that it has a comparatively higher proportion of carbon and/or nitrogen, which may be represented, for example, on the basis of micrographs.

The surface layer containing carbon and/or nitrogen is implemented according to the present invention by at least one measure for the diffusion of carbon and/or nitrogen into near-surface areas of the rolling bearing element. Therefore, as a function of the particular concretely selected measure, within the scope of the measure for the diffusion of carbon and/or nitrogen into near-surface areas of the rolling bearing element, for the diffusion of carbon and/or nitrogen into near-surface areas of the rolling bearing element or the process parameters used in this context in each case, respectively, for example, temperature, pressure, duration, concentration of the carbon and/or nitrogen content of an optionally required carbon and/or nitrogen atmosphere, which may influence in a targeted manner the surface layer of the rolling bearing element containing carbon and/or nitrogen, which is to be implemented or is implemented. In particular, in this way the penetration depth of the carbon and/or nitrogen atoms and the concentration of the carbon and/or nitrogen atoms in the surface layer containing carbon and/or nitrogen may be influenced or controlled in the process. For example, it is possible, when carrying out the measure for the diffusion of carbon and/or nitrogen into the near-surface areas of the rolling bearing element, to implement the surface layer containing carbon and/or nitrogen, by setting a suitable temperature, i.e., in particular a temperature less than 500° C., to not risk any negative influence, which is to be attributed in particular to the temperature-related traveling of dislocations, on the mechanical properties of the austenitic steel forming the rolling bearing element. The mechanical properties such as hardness, wear resistance, overrolling resistance, etc., of the steel used may thus be essentially maintained.

Furthermore, negative influence of the dimensions or sizes and also the surface quality, i.e., in particular the roughness of the rolling bearing element, is also to be precluded or only recorded to a minor extent due to a suitable, comparatively low process temperature.

In particular a thermochemical treatment of the rolling bearing element comes into consideration as a corresponding measure for the diffusion of carbon and/or nitrogen into near-surface areas of the rolling bearing element, i.e., the diffusion in of carbon and/or nitrogen to implement the surface layer containing carbon and/or nitrogen is advantageously based on a thermochemical treatment of the rolling bearing element.

Due to a suitable process selection and process control of the at least one measure for diffusion of carbon and/or nitrogen into near-surface areas of the rolling bearing element to implement the surface layer containing carbon and/or nitrogen, it may have in particular hardnesses in the range of 800 HV-1500 HV (hardness Vickers), in particular greater than 900 HV. Fundamentally, high hardnesses of the surface layer containing carbon and/or nitrogen are preferably desirable, since they have a substantial influence on the wear resistance of the rolling bearing element. Of course, the hardness of the surface layer containing carbon and/or nitrogen may also be less than 800 HV or greater than 1500 HV in exceptional cases or in sections.

Similarly, due to a suitable process selection and process control of the at least one measure for the diffusion of carbon and/or nitrogen into near-surface areas of the rolling bearing element to implement the surface layer containing carbon and/or nitrogen, the layer thickness thereof may be set. The surface layer containing carbon and/or nitrogen may thus have, for example, a layer thickness of 1 μm to 50 μm, preferably of 2.5 μm to 40 μm, particularly preferably of 5 μm to 25 μm. Of course, the layer thickness of the surface layer containing carbon and/or nitrogen may also be less than 2.5 μm or greater than 40 μm in exceptional cases or in sections.

The rolling bearing element according to the present invention may be manufactured by the method described hereafter for manufacturing a rolling bearing element, in particular a rolling bearing ring, having a surface layer containing carbon and/or nitrogen, which thus also represents a part of the present invention.

The method according to the present invention includes the following steps:

providing a rolling bearing element made of an austenitic steel, which has a composition of 16-21 mass-% chromium, 16-21 mass-% manganese, 0.5 to 2.0 mass-% molybdenum, a total of 0.8 to 1.1 mass-% carbon and nitrogen, the ratio of carbon to nitrogen being 0.5 to 1.1, up to 2.5 mass-% melting-related impurities, and a remainder of mass-% of iron, the total of all components resulting in 100 mass-%, or

providing a rolling bearing element made of an austenitic steel, which has a composition of 16-21 mass-% chromium, 16-21 mass-% manganese, either greater than 2 mass-% molybdenum or less than or equal to 2 mass-% copper, or greater than or equal to 2 mass-% molybdenum and 0.25 to 2 mass-% copper, and a total of greater than 0.5 mass-% carbon and nitrogen, the ratio of carbon to nitrogen being greater than 0.5, up to 2.5 mass-% melting-related impurities, and a remainder of mass-% of iron, the total of all components resulting in 100 mass-%, and

carrying out at least one measure for the diffusion of carbon and/or nitrogen into near-surface areas of the rolling bearing element to implement the surface layer containing carbon and/or nitrogen.

The above statements on the rolling bearing element according to the present invention fundamentally apply to the method according to the present invention, i.e., in particular all statements in conjunction with surface layer containing carbon and/or nitrogen or the implementation thereof, respectively, i.e., similarly the measure or measures for the diffusion of carbon and/or nitrogen into near-surface areas of the rolling bearing element.

A thermochemical treatment of the rolling bearing element is preferably carried out as a measure for implementing the surface layer containing carbon and/or nitrogen. For this purpose, in particular the following processes come into consideration for diffusion of carbon and/or nitrogen into edge-proximate or near-surface areas of the rolling bearing element: Kolsterising, plasma carburization, plasma nitration, gas nitration, gas nitrocarburation. The processes may optionally also be carried out in combination or in chronological succession.

Kolsterising is generally understood as a diffusion of carbon into the material to be treated at temperatures less than 300° C., the carbon being dissolved in intermediate lattice sites of the starting material, which results in compressive stresses and in this way in a high hardness (greater than 1000 HV (hardness Vickers)).

Plasma carburization is used, while employing a plasma, for the diffusion of carbon into edge-proximate or near-surface areas of the material to be carburized. Similarly, due to the introduction of compressive stresses to be attributed to the intercalation of carbon, a high hardness may be achieved.

This also essentially applies for plasma nitration, of course nitrogen, not carbon, being diffused into the starting material to be treated here.

Gas nitration is a thermochemical method, in which the material to be treated, i.e., in particular to be hardened, is temperature treated and is subjected to a gas containing nitrogen, for example, ammonia (NH₃), which then results in the diffusion of nitrogen into the starting material.

In the case of gas nitrocarburation, in which a diffusion of carbon and nitrogen into the material to be treated is achieved, the material to be treated is additionally subjected to a gas containing carbon, for example, CO₂, i.e., overall to a gas mixture containing nitrogen and a gas containing carbon, and temperature treated accordingly.

Within the scope of experiments on the implementation of the surface layer containing carbon and/or nitrogen on corresponding rolling bearing elements, it has been shown that particularly good results with regard to the implementation of a surface layer containing nitrogen on corresponding rolling bearing elements are achievable by plasma nitration.

It is advantageous if the thermochemical treatment is carried out in a temperature range of 250° C. to 550° C., in particular less than 500° C., preferably less than 450° C. or 400° C. By setting the temperature applied within the scope of the thermochemical treatment, influence may be taken in a targeted way on the kinetics of the diffusion of carbon and/or nitrogen into the edge or surface area of the rolling bearing element, and in this way a specific property spectrum of the surface layer containing carbon and/or nitrogen to be formed may be set in a targeted way. Due to the comparatively low temperatures, temperature-related influences on the dimensional accuracy and/or surface quality or roughness of the rolling bearing element may be precluded or at least kept to a tolerable extent. Of course, the thermochemical treatment may also be carried out below 200° C. or above 550° C. in exceptional cases and/or temporarily.

The thermochemical treatment may be carried out in particular for a duration of 2 to 24 hours, in particular 4 to 16 hours. Similarly as in the setting of the temperature applied within the scope of carrying out the thermochemical treatment, the diffusion of carbon and/or nitrogen into the edge area or surface area of the rolling bearing element may be influenced in a targeted manner and a specific property spectrum of the surface layer containing carbon and/or nitrogen to be formed may thus be set in a targeted manner. Of course, the thermochemical treatment may also be carried out for less than 2 hours or longer than 24 hours in exceptional cases.

Fundamentally, the measure for implementing the surface layer containing carbon and/or nitrogen may be carried out in such a way that a surface layer containing carbon and/or nitrogen having a layer thickness of 1 μm to 50 μm, preferably 2.5 μm to 40 μm, particularly preferably 5 μm to 25 μm, is implemented. In exceptional cases, the layer thickness of the surface layer containing carbon and/or nitrogen may also be less than 1 μm or greater than 40 μm.

It is possible within the scope of the method according to the present invention that before carrying out the at least one measure for implementing the surface layer containing carbon and/or nitrogen, at least one measure for cold work hardening, in particular cold forming, of the rolling bearing element is carried out. Cold forming, which is among the measures for cold work hardening of a metallic material, is to be understood as plastic forming of metallic materials at a temperature significantly below the particular recrystallization temperature thereof. The plastic forming of the material increases the dislocation density within the material and thus causes an increase of the hardness. In this way, before carrying out the at least one measure for the diffusion of carbon and/or nitrogen into near-surface areas of the rolling bearing element to implement the surface layer containing carbon and/or nitrogen, which is to be carried out within the scope of the method according to the present invention, the mechanical properties of the rolling bearing element may already be increased, which are then elevated or improved once again, i.e., after carrying out the at least one measure for the diffusion of carbon and/or nitrogen into near-surface areas of the rolling bearing element to implement the surface layer containing carbon and/or nitrogen.

### BRIEF DESCRIPTION OF THE DRAWINGS

One exemplary embodiment of the present invention is illustrated in the drawings and will be described in greater detail hereafter.

FIG. 1 shows a rolling bearing, including multiple rolling bearing elements according to one exemplary specific embodiment of the present invention and

FIG. 2 shows an enlarged view of the detail shown in FIG. 1.

### DETAILED DESCRIPTION

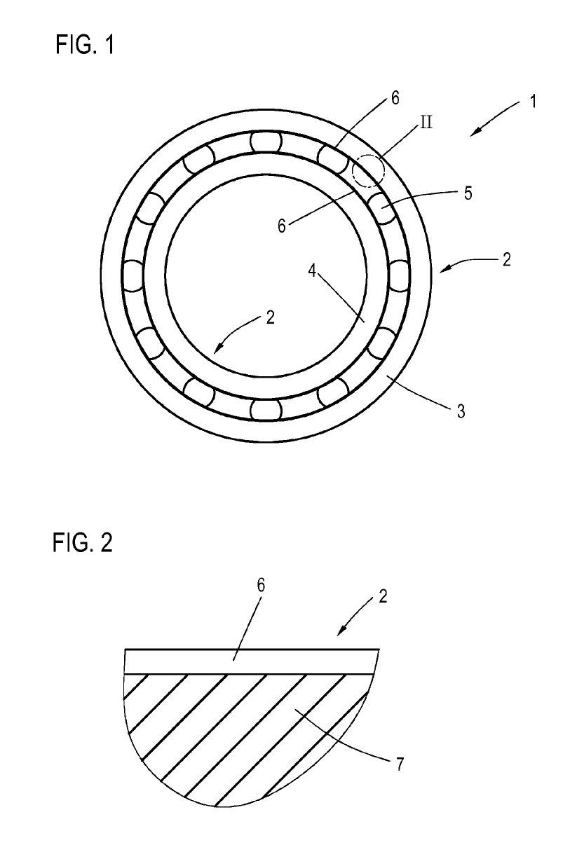

FIG. 1 shows a rolling bearing 1, including multiple rolling bearing elements 2 according to one exemplary specific embodiment of the present invention. Rolling bearing 1 is apparently provided as a ball bearing. Rolling bearing elements 2 are designed as rolling bearing rings 3, 4, between which rolling bodies 5 roll.

Rolling bearing elements 2, which are designed as rolling bearing rings 3, 4, are manufactured from an austenitic steel, this steel having a composition of 16-21 mass-% chromium, 16-21 mass-% manganese, 0.5 to 2.0 mass-% molybdenum, a total of 0.8 to 1.1 mass-% carbon and nitrogen, the ratio of carbon to nitrogen being 0.5 to 1.1, up to 2.5 mass-% melting-related impurities, and a remainder of mass-% of iron, the total of all components resulting in 100 mass-%.

Alternatively, one of rolling bearing elements 2 or both rolling bearing elements 2 may also be made of an austenitic steel, which has a composition of 16-21 mass-% chromium, 16-21 mass-% manganese, either greater than 2 mass-% molybdenum or less than or equal to 2 mass-% copper, or greater than or equal to 2 mass-% molybdenum and 0.25 to 2 mass-% copper, and a total of greater than 0.5 mass-% carbon and nitrogen, the ratio of carbon to nitrogen being greater than 0.5, 0.1 up to 2.5 mass-% melting-related impurities, and a remainder of mass-% of iron, the total of all components resulting in 100 mass-%.

Specific compositions of exemplary austenitic steels may be taken from the above-mentioned tables.

The inner and outer circumferences of rolling bearing elements 2, which form or include the tracks for rolling bodies 5, have a surface layer 6 containing nitrogen and/or carbon, which is formed by at least one measure for the diffusion of carbon and/or nitrogen into near-surface areas of the rolling bearing element.

Surface layer 6 containing carbon and/or nitrogen is particularly clearly apparent from FIG. 2, which shows the enlarged view of the detail shown in FIG. 1. It is shown that a surface layer 6 containing carbon and/or nitrogen having a largely homogeneous layer thickness d has formed. Surface layer 6 containing carbon and/or nitrogen has, for example, a layer thickness d of approximately 20 μm. Austenitic microstructure 7 of the steel forming rolling bearing element 2 is also shown.

Surface layer 6 is formed in particular with the aid of a thermochemical treatment or a thermochemical process for diffusion of carbon and/or nitrogen into edge-proximate or near-surface areas of rolling bearing elements 2. For example, the surface layer is formed by a plasma carburization or plasma nitration.

Surface layer 6 containing carbon and/or nitrogen therefore has, due to the diffused-in carbon or nitrogen, which is situated in particular on intermediate lattice sites of original microstructure 7 of the particular austenitic steel in the sense of interstitial atoms, a high hardness greater than 1000 HV, in particular in the range of 1200 HV, and therefore outstanding wear resistance.

The bond between surface layer 6 containing carbon and/or nitrogen and the remaining material or microstructure 7 of particular rolling bearing element 2 is very good, since surface layer 6 containing carbon and/or nitrogen is not applied as a coating to rolling bearing element 2, but rather was formed directly from steel or microstructure 7 forming rolling bearing element 2.

A corresponding rolling bearing element 2 may be manufactured, for example, by a manufacturing method described hereafter for manufacturing a rolling bearing element 2, in particular a rolling bearing ring 3, 4, having a surface layer 6 containing carbon and/or nitrogen.

According to the method, initially a rolling bearing element 2 made of an austenitic steel is provided, which has a composition of 16-21 mass-% chromium, 16-21 mass-% manganese, 0.5 to 2.0 mass-% molybdenum, a total of 0.8 to 1.1 mass-% carbon and nitrogen, the ratio of carbon to nitrogen being 0.5 to 1.1, 0.1 up to 2.5 mass-% melting-related impurities, and a remainder of mass-% of iron, the total of all components resulting in 100 mass-%.

The provision of a rolling bearing element 2, made of an austenitic steel, which has a composition of 16-21 mass-% chromium, 16-21 mass-% manganese, either greater than 2 mass-% molybdenum or less than or equal to 2 mass-% copper, or greater than or equal to 2 mass-% molybdenum and 0.25 to 2 mass-% copper, and a total of greater than 0.5 mass-% carbon and nitrogen, the ratio of carbon to nitrogen being greater than 0.5, 0.1 up to 2.5 mass-% melting-related impurities, and a remainder of mass-% of iron, the total of all components resulting in 100 mass-%, is also conceivable.

Specific compositions of exemplary austenitic steels may be taken, as mentioned, from the above-mentioned tables.

After the provision of rolling bearing element 2, at least one measure is carried out for the diffusion of carbon and/or nitrogen into near-surface areas of rolling bearing element 2 to implement surface layer 6 containing carbon and/or nitrogen.

A thermochemical treatment of rolling bearing element 2 is carried out as a measure for implementing surface layer 6 containing carbon and/or nitrogen. The thermochemical treatment of rolling bearing element 2 is carried out in particular in the form of Kolsterising and/or plasma carburization and/or plasma nitration and/or gas nitration and/or gas nitrocarburation.

So as not to negatively influence the dimensions and the surface quality, i.e., in particular the roughness of rolling bearing element 2, the thermochemical treatment is carried out at low temperatures in a temperature range of 250° C. to 550° C., in particular less than 500° C.

The thermochemical treatment of rolling bearing element 2 is typically carried out for a duration of 2 to 24 hours, in particular 4 to 16 hours. In this way, layer thicknesses d of corresponding surface layers 6 containing carbon and/or nitrogen of 1 μm to 50 μm, preferably 2.5 μm to 40 μm, particularly preferably 5 μm to 25 μm, may regularly be implemented.

It is possible that before carrying out the at least one measure for implementing surface layer 6 containing carbon and/or nitrogen, i.e., before carrying out the thermochemical treatment of rolling bearing element 2, at least one measure is carried out for cold work hardening, in particular cold forming, of rolling bearing element 2. This cold work hardening step may also be an essential part of the method according to the present invention. In this way, the property profile, i.e., in particular the mechanical properties of rolling bearing element 2, may already be improved before carrying out the at least one measure for implementing surface layer 6 containing carbon and/or nitrogen. This combination of measures results in a particularly advantageous component. The material according to the present invention causes the corrosion resistance, the cold work hardening (to 650-730 HV) causes the rolling bearing overrolling resistance, while the surface layer treatment causes the wear resistance. In contrast to martensites and standard austenites, the austenite “carnite” may increase by up to 300 HV in hardness at least in the surface layer down to a depth of approximately 1.5 mm. In contrast to martensites, a substantially precipitation-free surface layer up to approximately 50 μm may be set thermochemically. The high solubility of interstitial atoms in many austenites is typical. In the material used according to the present invention, this property is particularly well pronounced because of its high manganese content. In contrast to many martensites and some austenites, the hardness is not reduced as a result of relaxation during the thermochemical boundary treatment in the temperature range of 250° C.-550° C., so that a rolling bearing element having outstanding properties is obtained.

### LIST OF REFERENCE NUMERALS

1 rolling bearing
2 rolling bearing element
3 rolling bearing ring
4 rolling bearing ring
5 rolling body
6 surface layer containing carbon and/or nitrogen
7 microstructure

What is claimed is:

1-10. (canceled)

11. A rolling bearing element made of an austenitic steel having a composition of 16-21 mass-% chromium, 16-21 mass-% manganese, 0.5 to 2.0 mass-% molybdenum, a total of 0.8 to 1.1 mass-% carbon and nitrogen, the ratio of carbon to nitrogen being 0.5 to 1.1, up to 2.5 mass-% melting-related impurities, and a remainder of mass-% of iron, the total of all components resulting in 100 mass-%, the roller bearing element comprising:
a surface layer containing carbon or nitrogen and formed at least in part by diffusion of carbon or nitrogen into near-surface areas of the rolling bearing element.

12. The roller bearing element as recited in claim 11 wherein the roller bearing is a rolling bearing ring.

13. The rolling bearing element as recited in claim 11 wherein the surface layer containing carbon or nitrogen has a hardness of 800-1500 HV.

14. The rolling bearing element as recited in claim 13 wherein the hardness is greater than 900 HV.

15. The rolling bearing element as recited in claim 11 wherein the surface layer containing carbon or nitrogen has a layer thickness of 1 μm to 50 μm.

16. The rolling bearing element as recited in claim 15 wherein the surface layer containing carbon or nitrogen has a layer thickness of 2.5 μm to 40 μm.

17. The rolling bearing element as recited in claim 16 wherein the surface layer containing carbon or nitrogen has a layer thickness of 5 μm to 25 μm.

18. A rolling bearing element made of an austenitic steel having a composition of 16-21 mass-% chromium, 16-21 mass-% manganese, either greater than 2 mass-% molybdenum or less than or equal to 2 mass-% copper, or greater than or equal to 2 mass-% molybdenum and 0.25 to 2 mass-% copper, and a total of greater than 0.5 mass-% carbon and nitrogen, the ratio of carbon to nitrogen being greater than 0.5, up to 2.5 mass-% melting-related impurities, and a remainder of mass-% of iron, the total of all components resulting in 100 mass-%, the roller bearing element comprising:
a surface layer containing carbon or nitrogen formed by at least in part by diffusion of carbon or nitrogen into near-surface areas of the rolling bearing element.

19. The roller bearing element as recited in claim 18 wherein the roller bearing is a rolling bearing ring.

20. The rolling bearing element as recited in claim 18 wherein the surface layer containing carbon or nitrogen has a hardness of 800-1500 HV.

21. The rolling bearing element as recited in claim 20 wherein the hardness is greater than 900 HV.

22. The rolling bearing element as recited in claim 18 wherein the surface layer containing carbon or nitrogen has a layer thickness of 1 μm to 50 μm.

23. The rolling bearing element as recited in claim 22 wherein the surface layer containing carbon or nitrogen has a layer thickness of 2.5 μm to 40 μm.

24. The rolling bearing element as recited in claim 23 wherein the surface layer containing carbon or nitrogen has a layer thickness of 5 μm to 25 μm.

25. A method for manufacturing a rolling bearing element having a surface layer containing carbon or nitrogen, the method comprising:
providing a rolling bearing element made of an austenitic steel, which has a composition of 16-21 mass-% chromium, 16-21 mass-% manganese, 0.5 to 2.0 mass-% molybdenum, a total of 0.8 to 1.1 mass-% carbon and nitrogen, the ratio of carbon to nitrogen being 0.5 to 1.1, up to 2.5 mass-% melting-related impurities, and a remainder of mass-% of iron, the total of all components resulting in 100 mass-%, or providing a rolling bearing element made of an austenitic steel, which has a composition of 16-21 mass-% chromium, 16-21 mass-% manganese, either greater than 2 mass-% molybdenum or less than or equal to 2 mass-% copper, or greater than or equal to 2 mass-% molybdenum and 0.25 to 2 mass-% copper, and a total of greater than 0.5 mass-% carbon and nitrogen, the ratio of carbon to nitrogen being greater than 0.5, up to 2.5 mass-% melting-related impurities, and a remainder of mass-% of iron, the total of all components resulting in 100 mass-%, and
carrying out at least one measure for the diffusion of carbon or nitrogen into near-surface areas of the rolling bearing element to implement the surface layer containing carbon or nitrogen.

26. The method as recited in claim 25 wherein a thermochemical treatment of the rolling bearing element is carried out as a measure for implementing the surface layer containing carbon or nitrogen.

27. The method as recited in claim 26 wherein the thermochemical treatment is carried out in a temperature range of 250° C. to 550° C., in particular less than 500° C.

28. The method as recited in claim 26 wherein the thermochemical treatment is carried out for a duration of 2 to 24 hours, in particular 4 to 16 hours.

29. The method as recited in claim 25 wherein the measure for implementing the surface layer containing carbon or nitrogen is carried out in such a way that a surface layer containing carbon or nitrogen having a layer thickness (d) of 1 μm to 50 μm, preferably of 2.5 μm to 40 μm, particularly preferably of 5 μm to 25 μm, is implemented.

30. The method as recited in claim 25 wherein Kolsterising and/or plasma carburization and/or plasma nitration and/or gas nitration and/or gas nitrocarburation is carried out as a measure for implementing the surface layer containing nitrogen or carbon.
